(19) United States
(12) Patent Application Publication
(10) Pub. No.: US 2026/0194672 A1
(43) Pub. Date: Jul. 9, 2026

(54) REAL-TIME COMPLETION MONITORING USING DISTRIBUTED ACOUSTIC SENSING

(71) Applicant: CONOCOPHILLIPS COMPANY, Houston, TX (US)

(72) Inventors: Chengbo LI, Houston, TX (US); Kyle FRIEHAUF, Houston, TX (US); Baishali ROY, Houston, TX (US)

(21) Appl. No.: 19/418,474

(22) Filed: Dec. 12, 2025

Related U.S. Application Data
(60) Provisional application No. 63/733,343, filed on Dec. 12, 2024.

(51) Int. Cl. G01V 1/22; E21B 47/095; E21B 47/12; G01V 1/50

(52) U.S. Cl. CPC G01V 1/226; E21B 47/095; E21B 47/12; G01V 1/50

(57) ABSTRACT

Many downhole tools in subsurface wells use pump down darts or balls to activate different equipment. The detection of dart movement and activation of the downhole tool is difficult to confirm and has been documented through subtle changes in pressure, time and rate of flow, or other secondary means. With the incorporation of distributed acoustic fibers in new wells, a signal is available that can be used to visualize activities in the reservoir. By selecting different frequencies in DAS data with improved signal-to-noise ratios, an optimized routine was developed to enable real-time visualization of dart or ball movement and seating as the ball travels to the seat and interacts with the tool. In one example, a sleeve is actuated using a dart and visualized in real-time as the dart travels to the sleeve.

### CROSS-REFERENCE TO RELATED APPLICATIONS

This application is a non-provisional application which claims benefit under 35 USC § 119 (e) to U.S. Provisional Application Ser. No. 63/733,343 filed Dec. 12, 2024, entitled “Real-Time Completion Monitoring Using Distributed Acoustic Sensing,” which is incorporated herein in its entirety.

### FEDERALLY SPONSORED RESEARCH AND DEVELOPMENT

None.

### FIELD OF THE INVENTION

The invention is broadly related to the production of hydrocarbons from hydrocarbon bearing reservoirs and more specifically to the completion of hydrocarbon wells.

### BACKGROUND OF THE INVENTION

Hydrocarbon wells have progressed in complexity and design. There are three basic stages to produce hydrocarbons from subterranean reservoirs. First the well bore is drilled following a drilling plan and trajectory. The wellbore is then assessed and completed, followed by hydrocarbon production. In some instances the well is cased during drilling and in other situations the well is drilled first, then cased as part of the completion process. Completion generally encompasses the transition from drilling to production. However, with casing while drilling, multiple well stages, and workover of production wells, completion tools may be used at different times during the life of the well and may not be limited to specific stages, especially with sidetrack wells and improved reservoir management techniques. Completion tools may be used to hang casing liners, drill sidetrack wells, or fit new equipment into existing wells.

“Unlimited” frac sleeve completions use a pump-down device, known as a dart or ball, to sequentially open multiple sleeves along the wellbore and provide fluid isolation between stages, enabling continuous pumping without wireline runs. Unlike traditional ball-drop systems, these completions rely on a counting mechanism and are particularly advantageous for single-well operations. The opening and isolation of the frac sleeves is considered a significant execution risk and efforts are being made to mitigate and optimize this process. While some work has been done to use Fiber-optics in plug and perf wells which demonstrate the ability to diagnose allocations into multiple perforation clusters and consider stage isolation, this is only applicable to plug-and-perf operations where a bottom hole assembly (BHA) is installed which includes a frac plug, setting tool and perforating guns. After perforation, the frac plug is released and removed. The “unlimited” frac sleeve completion remains in the reservoir and can be used multiple treatments, if isolation between stages can be confirmed.

Completion systems are the components necessary to complete the well after it is drilled and prepare it for production. There are many completion options available and cased-hole completion systems vary from relatively simple single-zone low-pressure/low-temperature (LP/LT) designs to complex multiple-lateral high-pressure/high-temperature (HP/HT) integrated systems. Some of the basic components may appear similar to systems used in the past, yet may have been vastly improved, and their performance has been optimized to suit numerous environments. With multiple lateral wells, long horizontal wells, more complex completion equipment, the quality and effectiveness of different completion tools is difficult to verify, especially when some processes may require a series of actions to complete. Stopping to verify different stages can contribute to rig time delays and dramatically increase the cost of a project.

### SUMMARY OF THE INVENTION

Real-time evaluation of completion processes using fiber data provides a unique tool enabling field engineers to view completion events and respond quickly to correct or verify that a completion tool or process has functioned as designed. The incorporation of optical fiber sensors, including distributed acoustic sensors and distributed temperature sensors, provides a method to monitor activities along the wellbore with resolution reaching less than 1 meter or better. DAS/DTS optical fibers incorporated into a well completion provide a passive system to monitor completion and won't interfere with the completion or require separate tools for monitoring the completion. In one embodiment an instrumented well with a DAS/DTS fiber is provided that incorporates a cemented fiber optic cable between the formation and the casing. In another embodiment an instrumented well is provided with a DAS/DTS fiber incorporated in the annulus of the well between the production tubing and the casing. Thus a DAS/DTS system can monitor completion real-time throughout the process without interfering or requiring down-time for measurement. Additionally, fiber optic systems have become more robust and durable in recent years allowing DAS/DTS to be used in more difficult well environments and fiber protection can even protect fiber during fracturing operations, which would have been mutually exclusive in the past. Thus DAS/DTS optical fibers provide a unique system to monitor completion in real time.

The invention more particularly includes tracking a tool in an instrumented well bore by generating raw fiber data from an instrumented well bore comprising a DAS/DTS fiber along the length of the well bore and a DAS/DTS interrogator at the proximal end of the DAS/DTS fiber; receiving raw fiber data in real-time processing unit; transmitting raw fiber data to a cloud storage facility and a data curation processor, processing the raw fiber data to generate curated fiber data and calculated results, transmitting the curated data and calculated results to the cloud storage facility, and generating tracking results for the tool in real-time, and performing one or more activities related to tool operation in the well bore.

In one embodiment, a system for actuating a well tool comprises a well bore that includes a concentric tubing string and well casing, with one or more tools positioned downhole at the distal end of the tubing string. Along the length of the well casing, a Distributed Acoustic Sensing (DAS) fiber is installed, and a DAS interrogator is located at the proximal end of the DAS fiber, configured to collect data from the fiber. The system further includes a data processor that receives data from the DAS interrogator and is configured to transmit raw DAS interrogator data to both a data storage unit and a data curation module. The data curation module curates the fiber data and calculates result data, while the data storage unit receives and stores raw DAS interrogator data, curated fiber data, and calculated result data. An analytics engine is provided to analyze the raw DAS interrogator data, curated fiber data, and calculated result data, generating graphical displays, alerts, and operational parameters. Finally, an end user dashboard is configured to display one or more items selected from raw DAS interrogator data, curated fiber data, calculated results, graphical displays, alerts, and operational parameters.

In another embodiment, the invention includes a system for actuating a well tool in a well bore having a concentric tubing string and well casing, one or more tools downhole at the distal end of the tubing string, one or more tools having a collet for engaging a dart or ball, a launcher for a dart or ball at the proximal end of the tubing string, a DAS/DTS fiber along the length of the well casing, and a DAS/DTS interrogator at the proximal end of the DAS/DTS fiber; initiating the DAS/DTS interrogator to collect strain data from the DAS/DTS fiber; inserting a ball or dart into the launcher; launching the ball or dart into the tubing string while collecting strain data from the DAS/DTS fiber; processing the DAS/DTS fiber strain data during the pumping of the ball or dart toward the collet; plotting ball or dart position and velocity in real time while the ball or dart is traveling toward the collet; analyzing the ball or dart position upon landing at the collet; and adjusting the fluid pump or well pressure.

One embodiment of the invention includes monitoring completion in an instrumented well by providing an instrumented well bore having a well casing with a DAS/DTS fiber along the length of the well casing, and a DAS/DTS interrogator at the proximal end of the DAS/DTS fiber; initiating the DAS/DTS interrogator to collect strain data from the DAS/DTS fiber; performing one or more completion activities, generating raw fiber data from an instrumented well bore comprising a DAS/DTS fiber along the length of the well bore and a DAS/DTS interrogator at the proximal end of the DAS/DTS fiber; receiving raw fiber data in real-time processing unit; transmitting raw fiber data to a cloud storage facility and a data curation processor, processing the raw fiber data to generate a curated fiber data and calculated results, transmitting the curated data and calculated results to the cloud storage facility, generating tracking results for the completion activity in real-time, and adjusting one or more well parameters based on the tracking results.

The invention may be used to monitor one or more downhole well tools including a temporary plug, valve, sleeve, cross-over tool, dart, ball, pig, wiper, and a combination thereof.

The gauge length (GL) of the interrogator may be set to any commercially available GL including 1, 2, 3, 4, 5, 6, 7, 8, 9, 10, 15, or 20 meter GL or longer. In some instances a 2 meter GL may be used. In one embodiment, the DAS fiber may be a single-mode fiber having a gauge length of 2 meters.

The raw DAS/DTS signal may be analyzed in a frequency with an appropriate signal-to-noise ratio, including about 0-1 Hz, 1-10 Hz, 10-100 Hz, 100-500 Hz, 500-1000 Hz, 1000-2500 Hz, 2500-5000 Hz, 0-5000 Hz or a combination thereof. In other instances a narrower frequency may be used if the signal-to-noise ratio permits detection of the appropriate signal including 850-1300 nm, 850 nm, 1300 nm, 1310 nm, 1500 nm and 1550 nm. The DAS/DTS signal may also be analyzed in a frequency or range of frequencies selected based on the signal-to-noise ratio of the trimmed-mean based objective function that correlates with the tool or signal to be observed. In another embodiment, the acoustic data is analyzed in at least two frequency bands, a first frequency band for detecting stage isolation and a second frequency band for detecting sleeve activation. The processing may include applying a velocity scanning algorithm with a trimmed-mean objective function to determine the position and velocity of the pump-down device.

The acoustic data may be analyzed in a frequency band above 1 kHz to track movement of the pump-down device in real time. The completion tool may be a sliding sleeve, and the pump-down device comprises a dart or ball. The detected event may include a strain change in the 10-100 Hz frequency band indicating stage isolation, or a strain release in the 100-500 Hz frequency band indicating sleeve opening. Information relating to the detected event may be displayed on a real-time dashboard accessible by the operator. In yet another embodiment, at least one operational parameter of the well completion may be adjusted in response to the detected event. An alert may be generated or remedial action initiated if certain events occur, such as the pump-down device fails to reach a predetermined position or if the completion tool fails to activate. The data may be processed on-site, using distributed processors, in the cloud, or any combination thereof.

As used herein the term “dart” or “ball” can typically be used interchangeably as a device dropped or pumped through a tubing or coiled tubing string to activate downhole equipment and tools. Typically, when a ball or dart is located on a landing seat, hydraulic pressure is generally applied to operate the tool mechanism. Once the tool has been operated, the ball or dart is removed typically by dissolution of the ball.

Many tools may be ball or dart operated, including temporary plugs, burst disks, valves, sleeves, cross-over tools, and other downhole tools. A variety of valves, including directional valves, check valves, pressure release valves, toe valves, circulation valves, cleanout valve, inflow valve; plugs; disks including rupture disks, glass disks, and the like; as well as flow control devices, including inflow control devices, interval control valves, configurable flow control valves, including passive, autonomous, and active FCDs. Tools including sleeves, valves, flow control devices, and the like may be activated by a ball or dart, a specific series of balls or darts, or they may be wired, timed, or controlled by specific pressure signals.

As used herein, a sliding sleeve is a device that has two separate pipe sections that overlap. In one position ports in the one pipe either align or do not align with ports in another sleeve. When a ball or dart engages a collet in one sleeve, it creates a seal within the well bore at that point. Pressure can then be increased, either by waiting a period of time or by increasing pump rate to actuate the sleeve moving the sleeves into a second position where the ports in both pipes are switched from either aligned to not aligned or, in the case of fracturing sleeves, the ports go from not aligned to aligned, allowing fluid to flow into the annulus surrounding the sliding sleeve. Because the sleeves are typically located near the end of the well in the reservoir, timing, pressure, and confirmation of actuation are a problem. Debris, scale, and corrosion further complicate the ease of operating a sliding sleeve. There are two items that are difficult to confirm from the surface, the first is accurate seating of the ball in the collet. If there is interference or an incomplete seal, the ball and collet may not provide sufficient pressure to activate the device. A sliding sleeve can be designed with one collet for one action or two collets, one to open the sleeve and another, different collet size to close the sleeve. If there are a series of tools, each tool will have a unique opening and/or closing collet of different sizes allowing different tools to be activated at different stages of the process. Once complete, the ball or dart may be removed through several methods including dissolving, milling, reverse circulation, or a combination of methods.

TABLE 1
Abbreviations

| Abbreviation | Term |
|---|---|
| AAPG | American Association of Petroleum Geologists |
| BHA | Bottom Hole Assembly |
| bpm | Barrels per minute |
| DAS | Distributed Acoustic Sensing |
| DTS | Distributed Temperature Sensing |
| FBE | Frequency Band Extraction |
| GL | Gauge Length |
| HP/HT | High Pressure/High Temperature |
| Hz | Hertz |
| LP/LT | Low Pressure/Low Temperature |
| SEG | Society of Exploration Geophysicists |
| SNR | Signal to Noise Ratio |
| SPE | Society of Petroleum Engineers |

### BRIEF DESCRIPTION OF DRAWINGS

The patent or application file contains at least one drawing executed in color. Copies of this patent or patent application publication with color drawing(s) will be provided by the Office upon request and payment of the necessary fee. A more complete understanding of the present invention and benefits thereof may be acquired by referring to the following description taken in conjunction with the accompanying drawings.

FIG. 1 is an automated tool tracker workflow.

FIG. 2 shows an experimental test loop used to monitor sleeve opening and closing.

FIG. 3 provides a sleeve open and stage isolation signal.

FIG. 4 demonstrates an automated dart tracker prototype.

FIG. 5 demonstrates a data plot for an auto-tracker.

FIG. 6 shows a sleeve open and stage isolation diagram.

FIG. 7 is an automated sleeve open and stage isolation workflow.

FIG. 8 shows a flow-loop setup with an “upper” sleeve and a “lower” sleeve.

FIG. 9A example data from engineered fiber with 10 m GL.

FIG. 9B example data from single-mode fiber with 10 m GL.

FIG. 9C example data from single-mode fiber with 2 m GL.

FIG. 10A automated dart tracking at 8 bpm.

FIG. 10B automated dart tracking at 10 bpm.

FIG. 10C automated dart tracking at 12 bpm.

FIG. 10D automated dart tracking at 15 bpm.

FIG. 11A estimated dart velocity vs. pump flow rate.

FIG. 11B estimated dart velocity vs. calculated fluid velocity.

FIG. 12 shows an onsite system.

FIG. 13 shows a cloud-based system.

FIG. 14 is a diagram of the Data Flow Schematic.

### DETAILED DESCRIPTION OF THE INVENTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

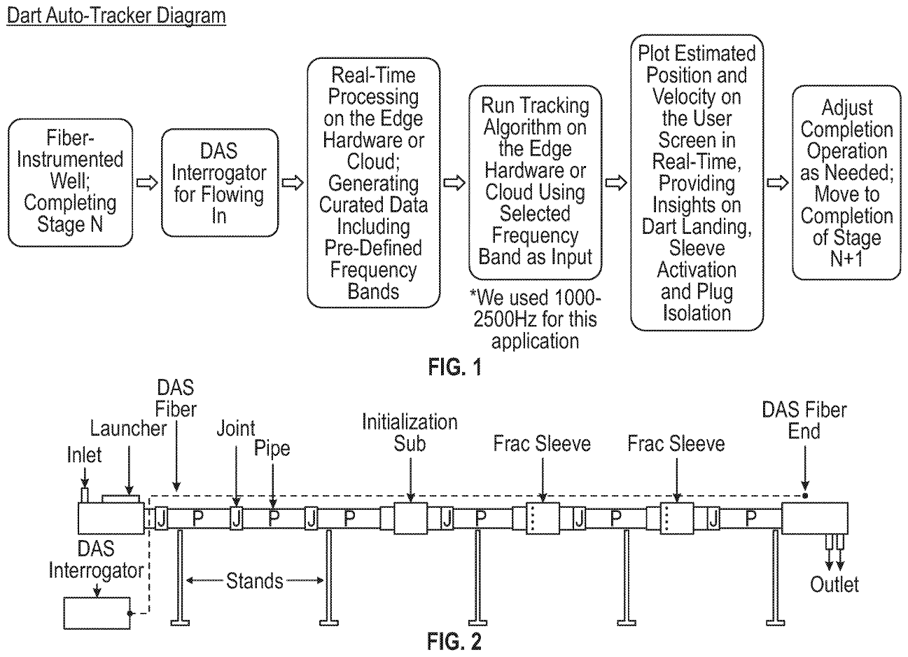

As shown in FIG. 1, a fiber instrumented well is provided. DAS interrogations are taken as circulation begins. Data collected from the DAS interrogator is processed either locally or in a cloud based processing system as the dart or ball enter the well bore. The analysis is two-fold, including a full frequency scan which may include scanning from 0-5 kHz, 0-10 kHz, and even 0-20 kHz, as well as generating a variety of pre-determined sub-frequency bands in real-time from the ‘raw’ full frequency data. If a strong signal is obtained, smaller bandwidths or multiple bandwidths may be monitored for different signals. Optimized pre-defined frequency bands are monitored, the tracking algorithm uses a selected frequency band as input dependent upon the signal-to-noise ratio and signal characteristics, the tracking system plots an estimated position and velocity on the user screen based on the tracking system data. The tracking system continues to update as the dart or ball travels, and the user can monitor in real-time the movement of the dart, landing of the dart or ball on the sleeve, activation of the sleeve, and plug isolation. The tracking system is continually updating through the process to ensure a clear signal is received and reported. The user can adjust the system based on the plot results in real time, if the dart slows or stops before reaching the designated sleeve location or doesn't stop passing the designated sleeve location, or if the sleeve doesn't fully actuate, if there is an incomplete seal, the user can maintain pumping pressure to achieve certain goals or change the completion process based on the real-time plot, or even pump another ball or dart. The operator is then ready to repeat the process for the next tool, stage, or step in the well development process.

Data from previous completions may be incorporated into tracking models, used to confirm well log data and equipment locations, and be used to update the well model as required and in real time. Updates may include areas of slowing such as tortuosity, buildup, doglegs, collet locations, and the like.

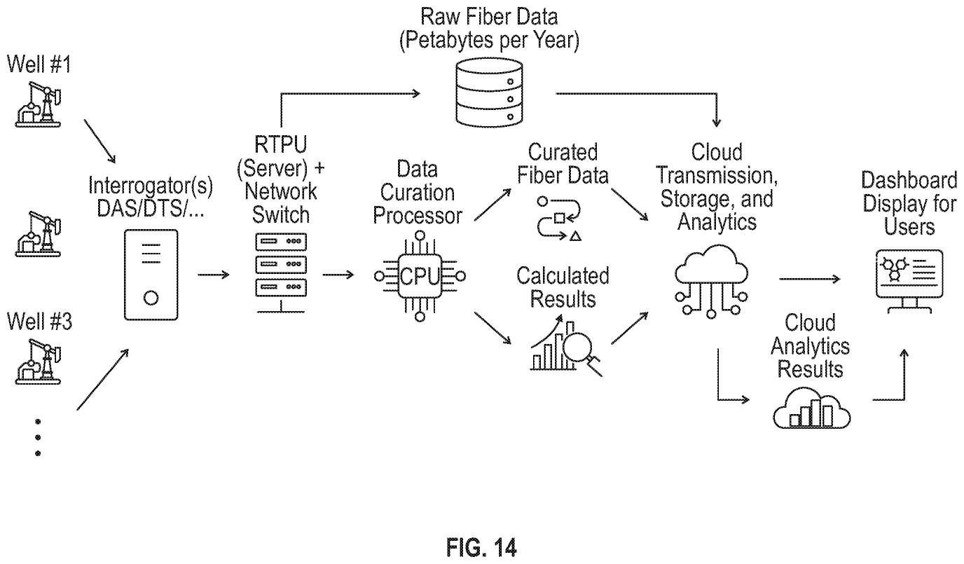

As shown in FIG. 14, real-time data analytics may include onsite, in transit, and cloud computing to curate and process the data, with raw data, curated data, results, and final dashboard all working collaboratively to provide processed results along with raw data in real time during tool activation allowing end users at different locations to monitor tool operation and make key analysis and decisions as the data is being produced. Instrumented wells are connected to a DAS/DTS Interrogator. If the wells are all at the same pad, multiple wells may be connected or use a single DAS/DTS interrogator. Alternatively, each well may have a dedicated Interrogator. The interrogator transmits and receives a DAS/DTS signal through the fiber optic cable, the DAS/DTS signal is received and transferred to an RTPU which transmits the data as required including uploading raw fiber data directly to a cloud storage system. The RTPU may also transmit the data to a Data Curation processor either locally or cloud based to curate the fiber data and fit the data to obtain computed results. The curated data and computed results are then stored alongside the raw data. Finally the data is retrieved or monitored by end users from the cloud storage. End users may be at the well site, in an office, or on a mobile device. The end user dashboard may include the raw data, curated data, calculated results and additionally analytics provided from the cloud to the end user display dashboard. In one embodiment velocity or location are mapped onto a well model as the data is retrieved from the cloud and transmitted to the end user. In another embodiment the calculated landing time is calculated and displayed on the end user dashboard. Finally a signal or indicator for landing is calculated and displayed on the end user dashboard.

Curated fiber data and calculated results may include a variety of processes including rolling averages, trimming of outliers, de-noising algorithms, filtering including bandwidth and bandpass filters, fitting of raw data to various functions including velocity, low-frequency data processing, downsampling of data, matching of data to identify characteristic signatures, and validation of the data to identify any erroneous signals. Characteristic signatures may include changes in pumping rate, opening or operating of the launcher, passing a collet, joint, landing, or other equipment signatures, seating and pressure increase signatures, sleeve opening signatures, water hammer signatures, and the like. Additionally well equipment including the ball or dart, collet, sleeve, valve, pump, or other well equipment may be fitted with a unique signature, flow meter, ring counter, opening/closing signal, or other equipment that provides known signatures for tracking purposes including a whistle, ping, fiberoptic, or vibrational signatures that can be easily identified or used to indicate equipment status or motion.

In one embodiment, the auto-tracking algorithm may be implemented using an optimization routine in a variety of platforms, including Python. The objective function may be a include a trimmed mean, median value, median value divided by the median absolute deviation, or any of the many objective functions available in a variety of platforms. By scanning the velocity with linear or polynomial fitting and maximize the objective function along the trajectory of the dart of ball in time and MD within a specified frequency range in real time. The raw data can be processed in real time and the velocity and position of the ball or dart may be plotted along the well model in real time and the ball traverses the length of the well.

The following examples of certain embodiments of the invention are given. Each example is provided by way of explanation of the invention, one of many embodiments of the invention, and the following examples should not be read to limit, or define, the scope of the invention.

### Example 1: Test Loop Evaluation

Real-time evaluation of sleeve completion is one of the key use cases identified for well completions. Previously dart or ball movement and actuation of downhole tools was presumed from changes in pressure detected at the surface. When a dart or ball engages a seat, flow is interrupted and pressure increases actuating one of the downhole tools. Until recently the only verification of tool actuation was the detected change in pressure consistent with tool activation. In order to better determine if a downhole tool is actually actuated, fiber data can be used to inform dart movement, observe sleeve opening, and verify plug isolation, enabling field engineers to respond quickly to either the proper actuation of a tool or provide remedial actions to correct the incorrect actuation of a tool. Critical fiber data was gathered using flow loop test to activate a sleeve using a dart. By analyzing fiber data gathered in a simple flow loop, tools can be developed to collect fiber data in more complex systems along the length of a wellbore, interpret the data in real time and provide actionable responses to the tool response before moving on to the next stage of completion.

An experimental flow loop was established to measure different signals present during different events in the flow loop. Initially the fiberoptic cable was placed along the flow loop. A baseline measurement was established for the fiber optic cable with no flow. Next the flow loop cycled through different events including initiating and stopping flow, shut down, and pumping a dart through the flow loop. Next the fiberoptic cable was taped to the flow loop and the process repeated including initiating and stopping flow, shut down, and pumping a frac plug through the flow loop.

Physically, the flow loop as shown in FIG. 1 comprises an inlet from the pump, a launcher for inserting a dart or ball, 3 sections of pipe including 3 joints, an initialization sub, a section of pipe including 1 joint, a first frac sleeve, a section of pipe including a joint, a second frac sleeve, a final section of pipe before the end of the pipe with two return outlets recycling water to the pump. The activation sub begins at 138.5 ft or 42.2 meters, the upper sleeve is located at 184.0 ft or 55.5 meters, the lower sleeve is located at 232.5 ft or 70.9 meters, with the end of the fiber terminating at 301 ft or 91.7 meters.

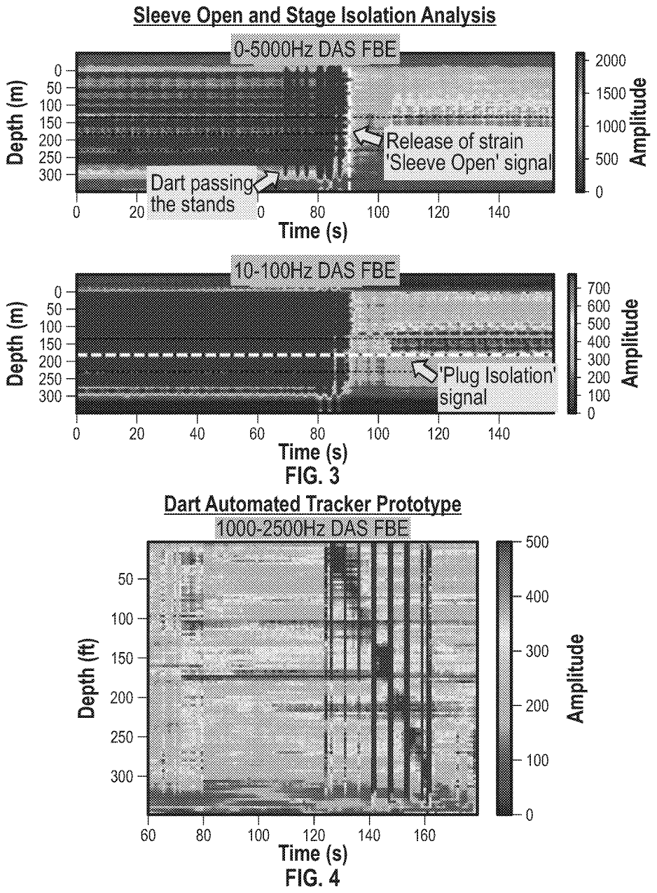

Using the flow loop an ideal fiber configuration and DAS interrogation protocol was established that would allow detection of sleeve actuation (FIG. 2) and develop an automated tracker tool that could track dart movement in real time (FIG. 3). The development of a tool that can monitor dart movement as the dart is pumped through the tubing is unique, previous studies required the acquisition of data, processing of the data, and finally interpretation of the data. This could not be done in real time and require days or weeks to process and analyze the data after the completion was finished. The present method allows monitoring of the completion in real time, analyzing the data as it is generated, starting at time 0, with the insertion of the dart or ball and monitoring the dart or ball as it moves through the well bore to the sleeve. The method provides detection of a strain change as the dart or ball is seated, confirming delivery of the ball or dart to the appropriate sleeve for activation. The method also provides detection of the sleeve actuation in real time, allowing confirmation of the sleeve activity or maintenance of pressure/strain until demonstrating the appropriate stage isolation. Finally the method provides a way to monitor release of pressure/strain once the sleeve is opened.

The test loop was used to assay a variety of fiber and interrogation methods to identify an appropriate signal-to-noise ratio (SNR) that allows automated real-time tracking of equipment and pressure changes. Observable signals were detected with all commercially available fiber optic cables and industry interrogators, although differences in signature and noise were observed. Rigorous testing and development confirmed dart movement can be measured and allowed development of an auto-tracker prototype. The auto-tracker is able to accurately measure dart location and velocity in real time, confirm sleeve opening in data by isolation instead of acoustic signature, and although stand pipes would not be part of real-time well monitoring, the stand-pipe signature could be removed allowing detection of dart launch, tubing joints, initialization sub, frac sleeve seating, and opening of the frac sleeve. DAS with smaller gauge length of 2 m was selected for the spatial resolution over SNR and the availability from a variety of fiber optic vendors. Interestingly, the real-time analysis demonstrated that the dart moves at slightly lower velocity than fluid as observed.

### Example 2: Real Time Tracker Plot

One aspect of the Dart Auto-Tracker is tracking dart position in real time. Using the test loop described above, a dart was pumped through the tubing to a collet in the sleeve. In order to track the dart in real time, real time signal fitting was used to identify a frequency band of DAS data with an adequate signal to noise ratio and signal characteristics for tracking dart movement. Initially there might be insufficient data but as the dataset increased the acoustic signal generated by the dart movement could be observed and recorded by the DAS interrogator. A gradual improvement on tracking accuracy is expected once passing the initial phase. An optimization routine was developed with an objective function using a trimmed mean amplitude to enable tracking of the dart's movement along the tubing. The real-time measurement provides both actual dart position in measured depth (MD) and the velocity of the dart during travel.

The first step was providing a fiber-instrumented well with a length of tubing, having an inlet providing fluid and a launcher for inserting a dart or ball, having a length of tubing sections followed by an initialization sub and one or more fac sleeves. The initialization sub and frac sleeves may be adjacent each other or may be separated by one or more sections of pipe, a centralizer, an orientation ring, or other tool, and optionally a bottom hole assembly or toe valve. When pumping fluid through the test loop a section of pipe with outlets was used to return fluid to the pump, fluid would flow through the sleeve and return up the annulus, depending upon the type of well and completion. In one embodiment, the fiber may be installed between the casing and the formation and cemented into place making the fiber coupled to the formation through the cement. In another embodiment the fiber may be installed permanently or temporarily in the annulus space between the frac string, production string or other downhole tool. Because the fiber optic cable is outside of the tubing and casing, all well processes may be monitored passively during the treatment or tool actuation.

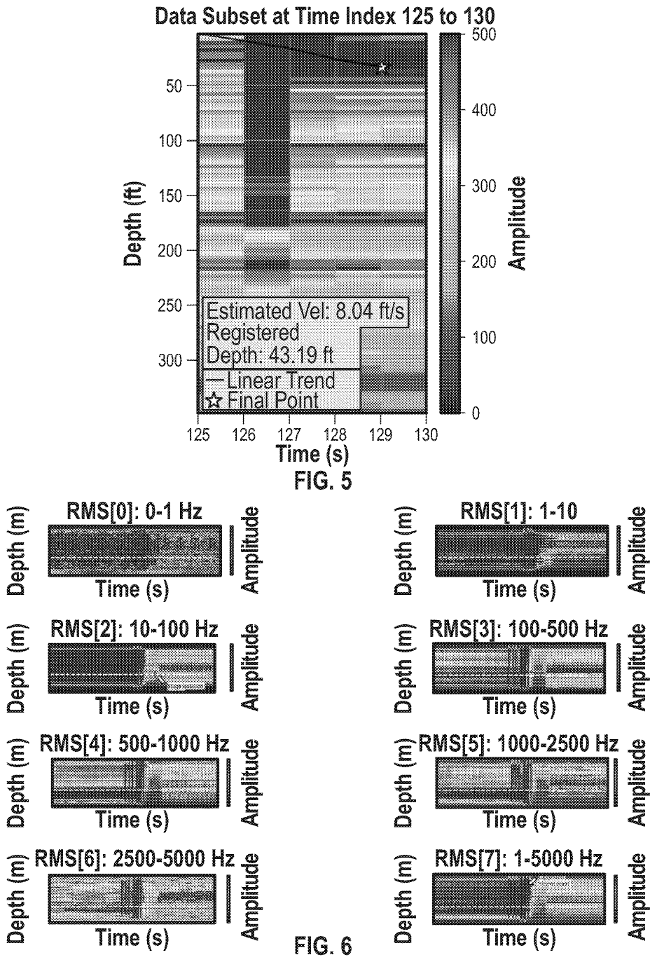

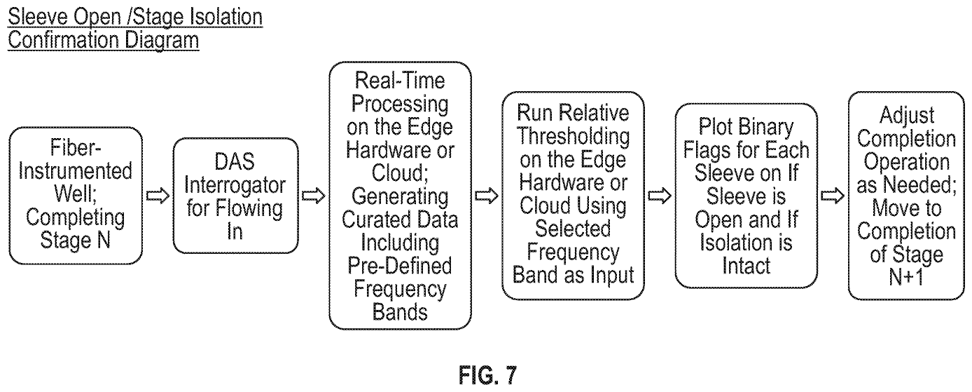

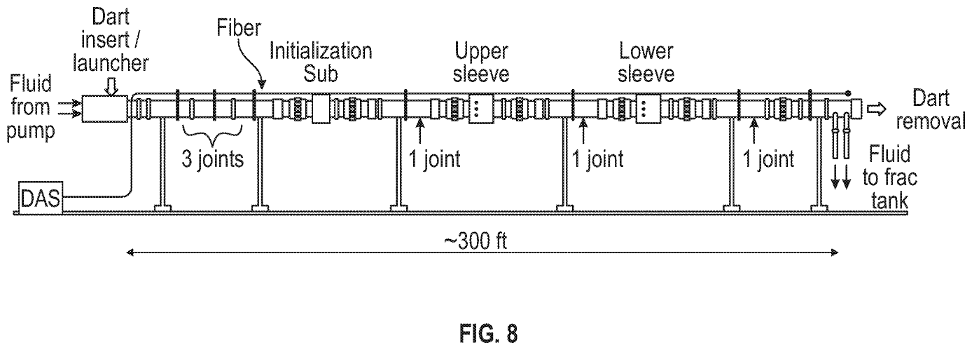

The DAS interrogator receives DAS data from the DAS fiber and converts the data to a DAS signal, the DAS signal is then streamed via either wireline or cloud based transmission to a flow analysis processor, the flow analysis process then generates a graphical representation of the dart movement on a tracking plot comprising depth and time in seconds as shown in FIG. 5, the plots are compiled into a real-time plot as shown in FIG. 4. It should be noted that the plot provides both visual confirmation for the user of dart position and speed, but also accurately tracks depth and velocity in real-time.

Depending upon the length of the well, type of interrogator used, type of optical fiber used, and accuracy required, the gauge length of the interrogator may be set to a 1, 2, 3, 4, 5, 6, 7, 8, 9, 10, 15, or 20 meter gauge length (GL) or longer. A shorter gauge length is preferred as it will provide greater detail. A visible signal sufficient for tracking and sleeve monitoring was received with both a 2 mGL and 10 mGL. A 2 mGL was selected for future use to improve resolution without any data analysis or processing issues. In other embodiments, the

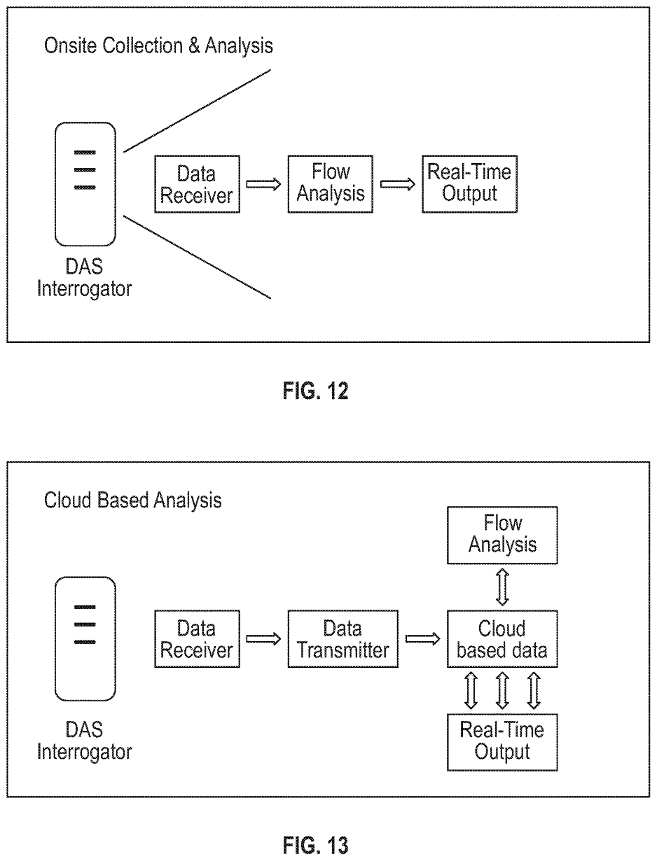

In one example the data may be generated and processed onsite. As shown in FIG. 12, the entire process of receiving data, processing the data, conducting the flow analysis and generating output may occur onsite at the well head. In some cases, the flow analysis may be performed by the interrogator itself as it receives the data using an internal real-time processing unit (RTPU) and flow analysis system, generating outputs of raw data, curated data, calculated results such as a real-time tracking plot, and a user dashboard displayed at the well site. Data and results processed as the well site may be transmitted the cloud for users outside the well site. This may also occur onsite if the interrogator is physically located in a job trailer and connected to a RTPU that can conduct the flow analysis onsite. In cases like FIG. 12, where the DAS interrogator and receiver are located onsite, the raw data, curated data, calculated results and final output may still be transmitted in real time to remote users for viewing and decision making.

In another example, as shown in FIG. 13, the data from the interrogator is received by a transmitter that transmits the data to a cloud based system or hard wire data line that transmits the data to a data storage location. In one embodiment the storage system is a cloud based storage system or data lake. RTPU and flow analysis can access the incoming data and process the data to generate an output in real time that is then either transmitted directly to users or input back to the data storage location. Data from the data storage location can be accessed by users in different locations in real time. In one embodiment an application on the users device provides a dashboard of well data from the data location. The dashboard of the application may provide many parameters in real-time including pump rate, pressure, temperature, dart location, dart velocity, tool depth, tool status, a visualization of the dart tracker, stage isolation, stage number, and the like. The dashboard may also simply show dart location and stage isolation alone.

In another embodiment, the dashboard may contain a well model that depicts the well trajectory including measured depth onto an overview of the well including different features located along the length of the well. The features may include the launcher, wellhead, collars, junctions, collets, heel, valves, packers, landing zones, shoe, and toe of the well, including the relevant inner diameter of the different features. The DAS signal is mapped onto these features as the dart or ball passes the different features, along with the relevant velocity information. As each feature is passed it may change color, light up, provide a signal or thumbs-up, to indicate the movement of the dart through the feature. Areas where the velocity changes, either increases or decreases, or is less than expected may be highlighted as well. When the landing for the current specified collet is achieved, an alert may be transmitted to the user. In another embodiment the pump rate is automatically decreased or stopped when the ball or dart is correctly seated. In yet another embodiment, the pump rate is automatically decreased when a specific pressure or strain is detected at the current stage. In another embodiment, the user is alerted if the ball or dart seat is not complete and leaking is detected. Other alerts and/or actions may be programmed depending on the well configuration and detected event. If the ball or dart stops before the projected landing collet, an alarm may sound and or remedial activity initiated to prevent sticking or damage.

### Example 3: Real-Time Sleeve Completion Monitoring Using High-Frequency DAS

In one example, a flow-loop test was conducted to evaluate the performance of a real-time completion monitoring system utilizing distributed acoustic sensing (DAS) for “unlimited” frac sleeve completions. A horizontal flow pipe approximately 300 feet in length was assembled using multiple joints of 4.5″ diameter, 13.5 lb/ft P-110 casing. The pipe was supported on adjustable stands to ensure a level configuration. Three key hardware components were installed: an initiation sub for the sleeve counting system and two frac sleeves, both initially in the closed position. When the dart passes through the initiation sub, it triggers the counting mechanism for sleeves. The two sleeves, referred to as the ‘upper’ and ‘lower’ ones, were activated in a reverse sequence, with the lower sleeve opening first, despite being the second sleeve encountered by the dart during pump-down. Fluid is pumped in at the upper end of the pipe and exits into a storage tank. Once it reaches the end of the pipe, the dart can be retrieved and reused. A fiber-optic cable was externally taped along the length of the pipe.

The experiment was divided into three main phases. First, baseline testing was conducted by pumping fluid at rates of 8, 10, 12, and 15 barrels per minute (bpm) without dart operations to establish baseline DAS data. Next, a dart was pumped at various rates without activating the sleeves, generating DAS data to assess the feasibility of real-time dart tracking. Finally, the sleeves were sequentially opened by pumping darts at 12 bpm, thereby simulating a multi-stage sleeve completion process.

TABLE 2
Experiment operation plan for the flow-loop test.

| Test | Step | Pump Rate (bpm) |
|---|---|---|
| Rate Baselines | Baseline Pumping | 8 |
| | Baseline Pumping | 10 |
| | Baseline Pumping | 12 |
| | Baseline Pumping | 15 |
| | Baseline Pumping | 8 |
| Pump Dart - | Prepare Dart | 2 |
| No Sleeve Opening | Pump Dart | 8 |
| | Retrieve and Prepare Dart | 2 |
| | Pump Dart | 10 |
| | Retrieve and Prepare Dart | 2 |
| | Pump Dart | 12 |
| | Retrieve and Prepare Dart | 2 |
| | Pump Dart | 15 |
| Pump Dart - | Prepare Dart | 2 |
| Open Sleeves | Open Lower Sleeve | 12 |
| | Prepare Dart | 2 |
| | Open Upper Sleeve | 12 |

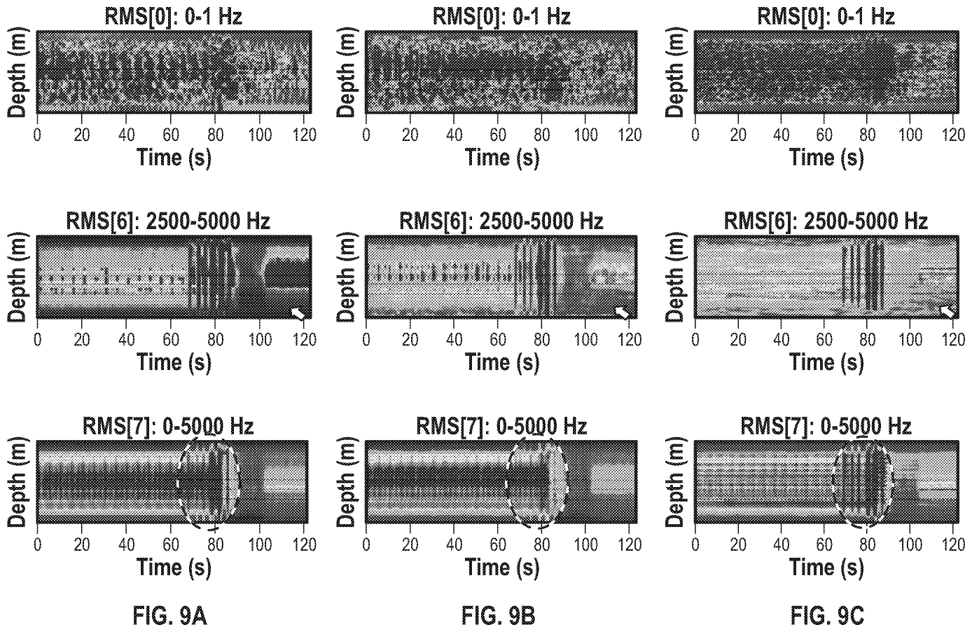

Three fiber configurations were tested, as shown in FIG. 9, an engineered fiber with a 10 m gauge length (GL), a single-mode fiber with a 10 m GL, and a single-mode fiber with a 2 m GL. All fibers were interrogated simultaneously. To assess the performance of different fiber-optic configurations and determine the optimal setup, the three fiber types were deployed externally along the casing and interrogated simultaneously. The DAS data was recorded from all three fibers during one of the dart pumping steps. From left to right, the three columns in FIG. 9 display data from an engineered fiber with a 10 m GL (9A), a single-mode fiber with a 10 m GL (9B), and a single-mode fiber with a 2 m GL (9C). The rows correspond to frequency band extractions (FBEs) in the low (0-1 Hz), high (2500-5000 Hz), and full (0-5000 Hz) ranges. The 2 m GL single-mode fiber provided the highest spatial resolution, which was essential for accurately capturing dart movement and sleeve activation signals, despite slightly higher noise compared to longer GLs.

DAS data was analyzed across multiple frequency bands, with the 10-100 Hz range used to detect strain changes associated with stage isolation when the dart reached its position after activating the sleeve, the 100-500 Hz range used to identify strain release signals corresponding to sleeve opening events, and the 1000-2500 Hz range used for real-time tracking of dart movement along the pipe. The rows in FIG. 9 correspond to frequency band extractions (FBEs) in the low (0-1 Hz), high (2500-5000 Hz), and full (0-5000 Hz) ranges. The FBEs below 1 Hz, which are associated with slow strains, exhibited minimal differences in signal/noise characters across all fiber types and gauge lengths. At higher frequencies, the engineered fiber demonstrated the highest signal-to-noise ratio (SNR) highlighted by the yellow arrows. Among the two single-mode fibers, the 2 m GL configuration exhibited slightly higher noise levels due to reduced spatial averaging. When examining the full-band data in the circled area, distinct vertical stripes were observed, which are interpreted as the dart passing the pipe stands and inducing mechanical vibrations. The 2 m GL fiber provided the highest resolution among the three, capturing finer details of the dart movement signal compared to the two fibers with 10 m GL.

Following a comprehensive analysis of all datasets across different sensing stages, we concluded that all three fibers provided sufficient SNR for monitoring sleeve completion. However, the higher resolution from the 2 m GL fiber is essential for accurately capturing signals from the dart moving at high rates and detecting sleeve activation. In one embodiment, an engineered fiber with a smaller GL may be used to obtain high quality data with full band data.

To achieve real-time visualization and validation of unlimited sleeve completion operations, the analysis focused on three aspects: tracking dart movement, confirming sleeve opening, and validating stage isolation. It was found that low-frequency DAS data (<10 Hz) is not suitable for detecting these events, while mid-frequency bands (10-100 Hz and 100-500 Hz) effectively reveal stage isolation and sleeve opening signatures, respectively. High-frequency data (above 1 kHz) enables real-time tracking of dart movement. The study recommends jointly using the 10-100 Hz and 100-500 Hz bands for interpreting sleeve events and the 1000-2500 Hz range for tracking dart movement.

FIG. 6 shows eight DAS FBE data recorded during the pumping a dart to open the upper frac sleeve. The panels are arranged in order from low to high frequencies, with the final panel displaying full-band data. The top two plots in FIG. 6 show low-frequency DAS data (<10 Hz) is unsuitable for monitoring sleeve completion with this configuration as it lacks the details required to detect instantaneous pressure or acoustic signals. It is important to test different configurations to ensure the FBE is sensitive in the frequency range being analyzed.

Our analysis focuses on mid- and high-frequency bands. In the 10-100 Hz range, in FIG. 6, a distinct strain change is observed above and below the upper sleeve location, as indicated by the white dashed line. This change is interpreted as stage isolation, occurring when the dart reaches its position after activating the sleeve. In the 100-500 Hz range, a strain release signal is clearly observed, with the white dashed line marking the estimated time of sleeve shifted open. Field observations further support this interpretation, as the pressure fluctuation exhibits an initial sudden drop followed by a rebound when the frac sleeve opens.

Another objective is to use DAS acoustics to track dart movement. As indicated in FIG. 6, a linear trend of acoustic signature can be observed using the FBE above 1 kHz as the dart travels through the flow pipe, despite strong background noise. Real-time visualization of dart movement is essential for diagnosing sleeve activation and inactivation during completion operations. To achieve this, a robust, automated tracking algorithm was developed that uses velocity scanning and a trimmed-mean objective function to maximize acoustic energy along the dart's path, operating directly on raw DAS data with minimal conditioning. The algorithm reports dart position and velocity every 5 seconds and remains effective even at high pump rates with significant noise.

Unlike conventional fiber data analysis, typically performed post-acquisition, real-time tracking imposes a different set of requirements for the methodology. Minimal data conditioning, sufficient automation, and the ability to operate with limited auxiliary data are critical, while the algorithm must be robust to various noise and computationally efficient for real-time execution on an edge device. A simple but robust optimization routine was implemented based on velocity scanning with a locally constant velocity assumption. It maximizes the acoustic energy along the trajectory using a ‘trimmed-mean’ objective function. The trimmed-mean approach was chosen for its robustness against noise in fiber data, which often manifests as high-amplitude anomalies that could severely skew the fitting. The algorithm follows a structured approach: selecting the most recent data within a time window of n seconds, performing velocity scanning within a predefined range to maximize energy along the scanning trajectory, determining the best fit and estimating the velocity and dart position, and finally, repeating the process at n-second intervals.

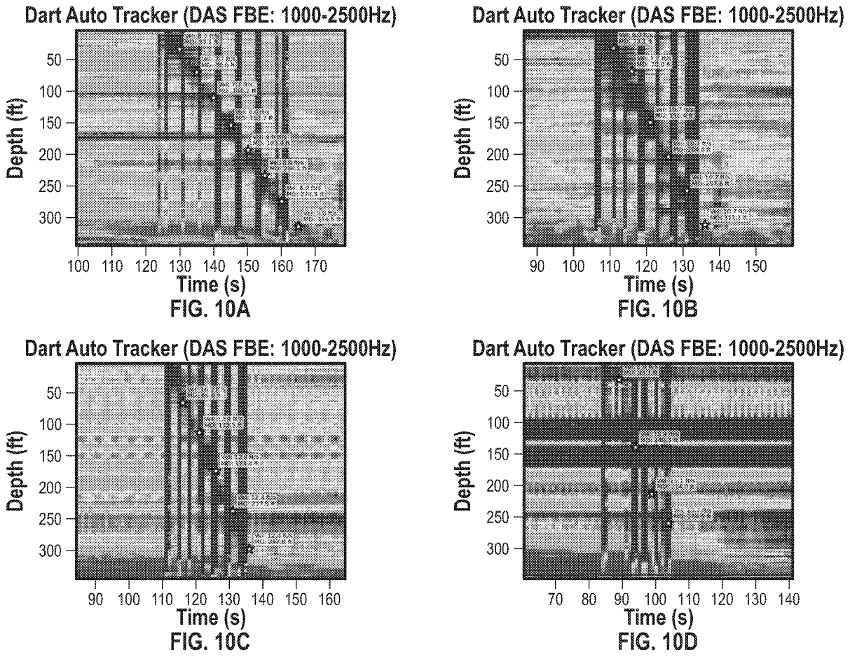

FIG. 10 presents snapshots of dart tracking at pump rates of 8, 10, 12, and 15 bpm using the proposed algorithm. Notably, no pre-conditioning was applied to the data, and tracking was performed directly on raw 100-2500 Hz FBE. At higher pump rates, the data exhibited significantly greater noise, primarily due to the direct connection between the surface pump and the flow pipe-higher pumping intensity led to stronger pipe vibrations. Dart velocities and locations (in MD) were reported every 5 seconds as data was received, simulating an in-field real-time scenario. Despite the increased noise at 15 bpm, where little signal is visually discernible, the algorithm successfully identified the trend with acceptable errors. In downhole conditions, we anticipate even higher pump rates for efficient operations but reduced noise level due to the sleeves being cemented in place.

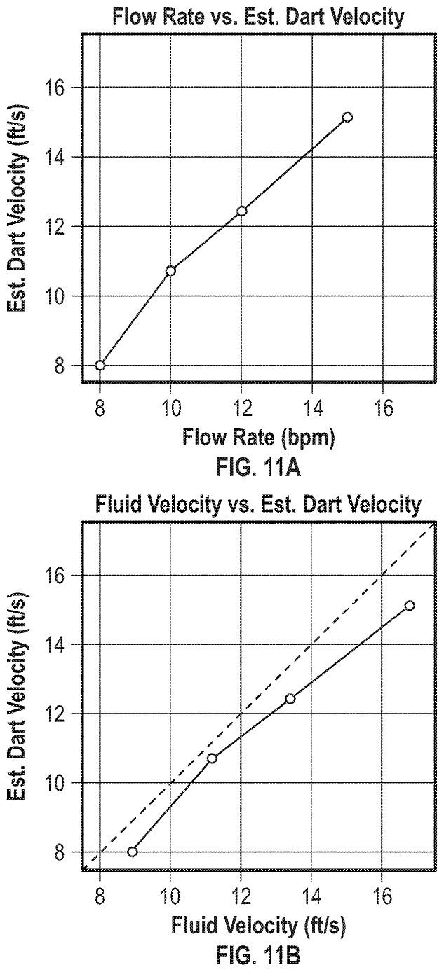

To further evaluate the analysis, we examined the relationship between estimated dart velocity and flow rates, where a linear trend is expected. FIG. 11A shows the estimated average dart velocity versus pump rate, while FIG. 11B compares the estimated dart velocity with the calculated fluid velocity, derived using flow rate and casing diameter. In both cases, a nearly linear relationship is evident. The dashed black line in FIG. 11B represents the equal velocity trend, and our results consistently show the estimated dart velocity to be approximately 10% lower than the calculated fluid velocity. This observation aligns with the expected behavior of the dart traveling at a slightly reduced speed compared to the surrounding fluid, mainly due to drag forces. This approach enables reliable, in-field, real-time tracking of dart movement under varying operational conditions.

These results demonstrate that high-frequency DAS enables effective real-time tracking and monitoring of “unlimited” sleeve completion systems, providing a comprehensive wellbore view and allowing operators to assess sleeve activation and inactivation, make data-driven decisions, and optimize efficiency during operations. This approach supports immediate corrective actions and is superior to conventional methods like surface pressure gauges and post-completion logs. In one embodiment, a 2-meter gauge length may be used to achieve a high spatial resolution, with ongoing consideration of the balance between resolution and signal-to-noise ratio. The automated tracking and interpretation methods may be integrated into real-time dashboards and are expected to enhance operational efficiency and reduce uncertainties in field development projects.

### Example 4: Real Time Field Operation

Provided an instrumented well, the tracking of a dart, change in fluid pressure/density/temperature, or other well procedure may be monitored in real-time using a DAS/DTS interrogator, RTPU, Data and Curation processor to generate curated data and calculated results which may be generated and stored in the cloud for display on user dashboards. The instrumented well may have the fiber optic cable installed in the annulus (temporarily or permanently, or the fiber optic cable may be cemented in the formation with the casing. Activity in the well may be actively monitored by periodic interrogation and automatic identification of changes in status. Changes in formation, temperature, and downhole equipment may be detected through changes in strain at the fiber optic cable. Tracking well status over time will improve well operation and remove incidents where unforeseen changes in the well can cause tortuosity, collapse or loss into the formation.

The instrumented well also provides a way to monitor tools as the different stages of well completion are accomplished. The opening or closing of a toe valve, installation of a screen or sleeve, actuation of a downhole tool. The instrumented fiber optic well also provides a direct link to tools downhole allowing communication of well data such as pressure, temperature, conductivity, and the like; tool status, such as open, closed, recording, transmitting, data transfer, and the like providing and accurate and rapid conduit along the length of the well.

Accurate monitoring of downhole events provides a unique window and verification of many activities that were previously assumed based on changes in pressure, pumping rates, time from drop, total volume, or secondary indicia. By monitoring changes in real-time and using the real-time auto-tracker, well operators have finally provided an actionable view into activities in the well for the total depth of the well. If a fluid of different viscosity or temperature is being pumped, or a plug, pig, wiper, dart, or ball is used to separate the two fluids, the movement of the fluid front may be tracked from the wellhead to the toe of the well. The fluid or tool may be observed traveling through different collets, tubing joints, centralizers, and other well features before finally exiting at the toe of the well. Logging and other well tools can be observed in real time and their location pinpointed with respect to the tubing or casing using a fiber optic instrumented well. Previously well operators counted on volume, time, or pressure changes and may have overpumped or (accidentally) underpumped the well. Using an instrumented fiber optic well with DAS/DTS ensures precise location of any well procedure that has or may be made to generate an acoustic strain or temperature signature detectable with a DAS or DTS interrogator.

In one embodiment an instrumented well is provided with a fiber optic cable cemented with the casing into the formation. During completion, the well is monitored as a dart or ball is dropped to isolate the fracturing stage from the remainder of the well beyond the current collet. The fiber optic cable is monitored during the process, from initial pumping, during insertion of the ball or dart into the launcher, during pump-down of the ball or dart as it passes through different well features including tubing joints, larger collets, the heel of the well, along the horizontal well, finally landing in the designated collet. The landing of the ball or dart in the collet is seen as a pressure increase. The pressure above the collet but not below the collet shows that the distal well bore is isolated from the current fracturing treatment. The sleeves for the current stage of fracturing are opened and can be observed as the pressure is released to the formation. In one embodiment, the signature of the ball landing can trigger a user alarm in real time. In another embodiment the opening of the sleeve can be confirmed through a signature change in pressure in the real-time tool tracker. The process may be repeated for the next stage of the fracturing process as each sleeve is actuated and the stage fractured. In one embodiment, remedial action may be taken when a ball or dart slows or stops but has not reached the appropriate depth. In another embodiment, where the ball or dart does not create a complete seal for the distal portion of the well, the flow and pressure may be reduced or reversed, before trying to seat the ball or dart again. In another embodiment, where the ball or dart fails to engage the collet and passes through the intended collet, a larger ball or dart may be dropped to ensure a proper seat is achieved.

In another embodiment a well with a cemented casing is provided that does not have a fiber optic cable installed. In this case, the well may be instrumented by inserting a fiber optic cable in the annulus of the well. The fiber optic cable may be coated for protection and to make the cable easily manipulated to the toe of the well. Once installed the cable may be fixed to offer permanent monitoring similar to the methods described above, or the fiber optic cable may be temporarily installed in the annulus of the well. It is important that the fiber optic cable does not interfere with procedures within the work string and allows free mobility of tools through the work string. A fiber optic cable within the work string may interfere with tool movement and would not allow a tight seat of the tool in the collet. A cable within the work string may also be damaged or destroyed by actuation of one or more valves, sleeves, or other downhole activities. Installation of a temporary or permanent fiber optic cable in the annulus between the work string and the casing prevents damage and protects the fiber optic cable from activities within the workstring.

In another embodiment, a fiber optic cable is attached to the inside of the installed casing after cementing but before installation of any work string or production tubing. The fiber optic cable may be rigid or flexible. The fiber optic cable may be installed and adhered to the casing by tape, glue or other adhesive. Alternatively the fiber optic cable may engage mounts within the casing to fasten the fiber optic cable to the wall of the casing. Additionally, the fiber optic cable may be installed in an open control line that may no longer be in use, or may be specifically provided for fiber optic cable.

Downhole tools may be designed to emit signals in an instrumented well with a fiber optic cable. In one embodiment a dart or ball may include a spinner that generates turbulence as it traverses the well. In another embodiment a ball or dart may contain a collar counter that chimes as it passes each collar. Because the fiber optic cable covers the total depth of the well, if a collar or joint is missed, the location of the missed collar will be known and can be investigated or corrected before a problem occurs, especially if the joint has failed or is about to fail. In another embodiment a valve or sleeve may contain a flapper or other signal generator that signals flow rate through an opening. This may be redundant as we have found that flow through a sleeve or valve can be readily observed using the real-time tool tracker. The presence of the flapper would ensure that flow is occurring through the intended port or may be used as an indicate of complete opening in the case of a sleeve or valve.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow. At the same time, each and every claim below is hereby incorporated into this detailed description or specification as an additional embodiments of the present invention.

### REFERENCES

In closing, it should be noted that the discussion of any reference is not an admission that it is prior art to the present invention, especially any reference that may have a publication date after the priority date of this application. Each of the references below is incorporated in their entirety for all purposes.
1. U.S. Pat. No. 10,095,828, Swan, et al., “Production Logs from Distributed Acoustic Sensors,” (2016).
2. U.S. Pat. No. 10,287,874, Jin, et al., “Hydraulic Fracture Monitoring by Low-Frequency DAS,” (2016).
3. U.S. Pat. No. 10,370,957, Jin, et al., “Measuring Downhole Temperature by Combining DAS/DTS Data,” (2016).
4. U.S. Pat. No. 10,458,228, Jin, et al., “Low Frequency Distributed Acoustic Sensing,” (2016).
5. U.S. Pat. No. 10,465,501, Friehauf, K. and Gibson, M. R., “DAS Method of Estimating Fluid Distribution,” (2016).
6. U.S. Pat. No. 10,808,521, Friehauf, Kyle, “Hydraulic Fracture Analysis,” (2013).
7. U.S. Pat. No. 10,890,058, Krueger, et al., “Low-Frequency DAS SNR Improvement,” (2016).
8. U.S. Pat. No. 11,021,934, Jin, et al., “Production Logging Inversion Based on DAS/DTS,” (2018).
9. U.S. Pat. No. 11,193,367, Jin, et al., “Low Frequency DAS Well Interference Evaluation,” (2018).
10. U.S. Pat. No. 11,255,997, Raterman, et al., “Stimulated Rock Volume Analysis,” (2017).
11. U.S. Pat. No. 11,352,878, Jin, G. and Roy, B., “Low Frequency Distributed Acoustic Sensing Hydraulic Fracture Geometry,” (2017).
12. U.S. Pat. No. 11,768,307, Jin, et al., “Machine-Learning Based Fracture-Hit Detection Using Low-Frequency DAS,” (2019).
13. US-2014-0358444, Dean, R. H. and Friehauf, K., “Method of Hydraulic Fracture Identification Using Temperature,” (2018).
14. US-2017-0260839, Beardmore, et al., “DAS for Well Ranging,” (2016).
15. US-2021-0277771, Pawar, et al., “Distributed Acoustic Sensing for Coiled Tubing Characteristics,”
16. Javaheri, et al., “Flow Profiling Using Fiber Optics in a Horizontal Steam Injector with Liner-Deployed Flow Control Devices,” SPE J. 26 (05): 3136-3150. doi.org/10.2118/200786-PA.
17. Davis, et al, ““A shift or not a shift?” that was the question: Robust qualification and testing of available “unlimited” frac sleeve systems yield varied results” Unconventional Resources Technology Conference, Denver, Colorado, USA (2023).
18. Boone, et al., “Monitoring hydraulic fracturing operations using fiber-optic distributed acoustic sensing” SPE/AAPG/SEG Unconventional Resources Technology Conference, San Antonio, Texas, USA (2015).
19. Ugueto, et al., “Perforation cluster efficiency of cemented plug and perf limited entry completions: insights from fiber optics diagnostics,” SPE Hydraulic Fracturing Technology Conference, The Woodlands, Texas (2016).
20. Cramer, et al., “Integrating distributed acoustic sensing, treatment-pressure analysis, and video-based perforation imaging to evaluate limited-entry-treatment effectiveness,” SPE Production & Operations, 35, 0730-0755 (2020).
21. Li, et al., “Distributed acoustic and temperature sensing applications for hydraulic fracture diagnostics,” SPE Hydraulic Fracturing Technology Conference and Exhibition, The Woodlands, Texas (2020).
22. Huckabee, et al., “Completions and stimulation experimental design, execution, analysis & application for the Permian Delaware Basin Hydraulic Fracture Test Site 2,” SPE Hydraulic Fracturing Technology Conference and Exhibition, The Woodlands, Texas, (2022).
23. Gustavo, et al., “Hydraulic fracture placement assessment in a fiber optic compatible coiled tubing activated cemented single point entry system,” SPE Hydraulic Fracturing Technology Conference and Exhibition, The Woodlands, Texas, (2018).
24. Farhadiroushan, et al., “Practical reservoir monitoring using distributed acoustic sensor with engineered fiber,” Second EAGE Workshop Practical Reservoir Monitoring Amsterdam, The Netherlands, (2019).
25. Jin, G. & Roy, B., “Hydraulic-fracture geometry characterization using low-frequency DAS signal” The Leading Edge, 36 (12), 975-980, (2017).
26. Jin, et al., “Fiber optic sensing-based production logging methods for low-rate oil producers,” SPE/AAPG/SEG Unconventional Resources Technology Conference, Denver, Colorado, (2019).

1. A method for tracking a tool in an instrumented well bore comprising:
generating raw fiber data from an instrumented well bore, said instrumented well bore comprising a Distributed Acoustic Sensing (DAS) fiber along the length of the well bore and a DAS interrogator at the proximal end of the DAS fiber;
receiving raw fiber data from the DAS interrogator in a real-time processing unit;
transmitting raw fiber data to a cloud storage facility or a data curation processor;
processing the raw fiber data to generate a curated fiber data and calculated results;
transmitting the curated data and calculated results to the cloud storage facility;
generating tracking results for the tool in real-time; and
performing one or more activities related to tool operation in the well bore.

2. The method of claim 1, wherein said one or more downhole well tools is selected from a temporary plug, valve, sleeve, cross-over tool, dart, ball, pig, wiper, and a combination thereof.

3. The method of claim 1, wherein the completion tool comprises a sliding sleeve, and the pump-down device comprises a dart or ball.

4. The method of claim 1, wherein a gauge-length of the interrogator is set to a gauge length (GL) selected from 1, 2, 3, 4, 5, 6, 7, 8, 9, 10, 15, or 20 meter or longer.

5. The method of claim 1, wherein one or more sets of data are analyzed in a frequency selected from between approximately 0-1 Hz, 1-10 Hz, 10-100 Hz, 100-500 Hz, 500-1000 Hz, 1000-2500 Hz, 2500-5000 Hz, 0-5000 Hz and a combination thereof.

6. The method of claim 1, wherein one or more sets of data are analyzed in a frequency selected based on the signal-to-noise ratio of the trimmed-mean based objective function that correlates with the signal.

7. The method of claim 1, wherein the acoustic data is analyzed in at least two frequency bands, a first frequency band for detecting stage isolation and a second frequency band for tracking ball or dart movement.

8. The method of claim 1, wherein the information relating to the detected event is displayed on a real-time dashboard accessible by one or more users.

9. The method of claim 1, wherein the method further comprises generating an alert or initiating a remedial action if the pump-down device fails to reach a predetermined position or if the completion tool fails to activate.

10. A system for actuating a well tool comprising:
a well bore comprising:
a concentric tubing string and well casing;
one or more tools downhole at the distal end of the tubing string;
a Distributed Acoustic Sensing (DAS) fiber along the length of the well casing; and
a DAS interrogator at the proximal end of the DAS fiber;
the DAS interrogator configured to collect data from the DAS fiber;
a data processor for receiving DAS interrogator data said data processor configured to transmit raw DAS interrogator data to a data storage and a data curation;
the data curation configured to curate fiber data and calculate result data;
the data storage configured to receive raw DAS interrogator data, curated fiber data and calculated result data;
an analytics engine configured to analyze raw DAS interrogator data, curated fiber data and calculated result data, said analytics engine generating graphical displays, alerts, and operational parameters; and
an end user dashboard configured to display one or more items selected from raw DAS interrogator data, curated fiber data, calculated results, graphical displays, alerts, and operational parameters.

11. The system of claim 10, wherein a gauge length of the interrogator is set to a gauge length (GL) selected from 1, 2, 3, 4, 5, 6, 7, 8, 9, 10, 15, or 20 meter or longer.

12. The system of claim 10, wherein one or more sets of data are analyzed in a frequency selected from between approximately 0-1 Hz, 1-10 Hz, 10-100 Hz, 100-500 Hz, 500-1000 Hz, 1000-2500 Hz, 2500-5000 Hz, 0-5000 Hz and a combination thereof.

13. The system of claim 10, wherein one or more sets of data are analyzed in a frequency selected based on the signal-to-noise ratio of the trimmed-mean based objective function that correlates with the signal.

14. The system of claim 10, wherein one or more sets of data are analyzed in at least two frequency bands, a first frequency band for detecting stage isolation and a second frequency band for tracking ball or dart movement.

15. The system of claim 10, wherein the information relating to the detected event is displayed on a real-time dashboard accessible by one or more users.

16. A method for monitoring completion in an instrumented well comprising:
providing an instrumented well bore, said instrumented well bore comprising a well casing with a Distributed Acoustic Sensing (DAS) fiber along the length of the well casing, and a DAS interrogator at the proximal end of the DAS fiber;
initiating the DAS interrogator to collect data from the DAS fiber;
performing one or more completion activities;
generating raw fiber data from said DAS interrogator on the instrumented well bore;
receiving raw fiber data in a real-time processing unit;
transmitting raw fiber data to a cloud storage facility and a data curation processor;
processing the raw fiber data to generate a curated fiber data and calculated results;
transmitting the curated data and calculated results to the cloud storage facility;
generating tracking results for the completion activity in real-time; and
adjusting one or more well parameters based on the tracking results.

17. The method of claim 16, wherein said one or more downhole well tools is selected from a temporary plug, valve, sleeve, cross-over tool, dart, ball, pig, wiper, and a combination thereof.

18. The method of claim 16, wherein the completion tool comprises a sliding sleeve, and the pump-down device comprises a dart or ball.

19. The method of claim 16, wherein a gauge length of the interrogator is set to a gauge length (GL) selected from 1, 2, 3, 4, 5, 6, 7, 8, 9, 10, 15, or 20 meter or longer.

20. The method of claim 16, wherein one or more sets of data are analyzed in a frequency selected from between approximately 0-1 Hz, 1-10 Hz, 10-100 Hz, 100-500 Hz, 500-1000 Hz, 1000-2500 Hz, 2500-5000 Hz, 0-5000 Hz and a combination thereof.

21. The method of claim 16, wherein one or more sets of data are analyzed in a frequency selected based on the signal-to-noise ratio of the trimmed-mean based objective function that correlates with the signal.

22. The method of claim 16, wherein one or more sets of data are analyzed in at least two frequency bands, a first frequency band for detecting stage isolation and a second frequency band for tracking ball or dart movement.

23. The method of claim 16, wherein the information relating to the detected event is displayed on a real-time dashboard accessible by one or more users.

24. The method of claim 16, wherein the method further comprises generating an alert or initiating a remedial action if the pump-down device fails to reach a predetermined position or if the completion tool fails to activate.
